(19) United States
(12) Patent Application Publication
(10) Pub. No.: US 2024/0346246 A1
(43) Pub. Date: Oct. 17, 2024

(54) Efficiently Extendable In-Interpreter Natural Language Agent

(71) Applicant: ServiceNow, Inc., Santa Clara, CA (US)

(72) Inventors: Torsten Scholak, Montreal (CA); Dzmitry Bahdanau, Montreal (CA)

(21) Appl. No.: 18/300,930

(22) Filed: Apr. 14, 2023

(51) Int. Cl. G06F 40/279

(52) U.S. Cl. CPC G06F 40/279

(57) ABSTRACT

A trained natural language model is provided that uses an input session history to generate outputs to an interpreter. Outputs to the interpreter, and inputs responsively received therefrom, are added to the history to generate additional model outputs as the history is updated. The model is trained to engage in goal-oriented dialog with the interpreter and with the user (optionally through interpreter function calls) to identify the user's goals, to learn information about modules, functions, and methods available in the interpreter that are relevant to the user's goals, and to execute function calls and/or commands, based on the learned information, that accomplish the user's goals. The use of a history that may be completely blank at the beginning of the session reduces the computational requirements of running the model, as well as allowing the model to ‘update’ itself as the available modules are update, added, or removed.

### BACKGROUND

In many applications, automated agents can be used to respond to user queries. Using automated agents can have the beneficial effect of reducing overall computing resource consumption by addressing some user concerns without resort to interaction with a human agent and/or accumulating relevant problem and/or query information from the user prior to eventual interaction with the human agent. The use of automated agents can also have the benefit of improving user experience by allowing for shorter-latency responses, and rapid resolutions to many problems.

### SUMMARY

Such automated agents can be configured to use available services or modules (e.g., knowledgebase access modules, user permissions database modules, reservation modules) in order to address user requirements. However, as such modules are updated (e.g., with additional functions or functionality, or with changes to such functions or functionality) and/or added to or subtracted from the set of modules available to an automated agent, the automated agent may require reconfiguration or retraining to adjust to these changes.

Automated virtual agents can address these issues efficiently, avoiding additional computing resource consumption associated with, for example, escalation to human agents (and making those interactions more efficient by pre-gathering relevant user inputs and information). However, such virtual agents can require significant configuration for a particular environment and application. Additionally, updates to the environment (e.g., addition, subtraction, and/or modification of application modules used by the virtual agent) can require additional effort to implement and/or additional computational resources to re-train the virtual agent to account for the updates. Such updates can occur regularly, imposing an ongoing burden.

Embodiments described herein provide improved virtual agents that reduce or avoid the computational overhead of retraining virtual agents in response to such updates. These improved virtual agents achieve such benefits by being trained (e.g., based on example dialogs) to interact with a user (e.g., to obtain the user's goals and relevant information) and to engage with an environment (via an interpreter that implements the environment) in a goal-directed manner in order to accomplish the user's goals and commands. This can include passing function calls, commands, or other inputs to the interpreter to learn about functions, methods, or other aspects of the environment that are available in order to determine which functionality of the environment is relevant to servicing a user's needs and to learn how to use such functionality.

The virtual agents described herein include natural language models that have been trained on examples of goal-oriented dialog toward the end of accomplishing users' goals and commands. These natural language models are trained to generate interpreter commands based on a history that grows during a session of interaction with a user. The commands generated by the trained natural language model, as well as any responsive returns from the interpreter, are added to the history as they are input/received, and the trained natural language model is then applied to the updated history to generate the next model output. Outputs from the trained model can include commands to send output to a user (e.g., to request additional information relevant to the detected user goal), to await input from a user, to access a list of modules available in the interpreter environment and/or information about the functionality of such modules, to access a list of functions, function calls, descriptions of function operations, or other information about individual modules and/or aspects thereof, to generate, assess, and/or execute function calls, or some other textual outputs that can be run by the interpreter and/or presented to a user.

The history is fully or partially discarded from one session to the next. This has the benefit of allowing the trained model to efficiently adapt to updates in the available modules by simply ‘forgetting’ the outdated information (e.g., module lists, module descriptions, module function call and function descriptions) and accessing such information anew with each session (via interpreter commands to access the current descriptions, lists, etc.). Note that such a history may, at the beginning of a new session be ‘pre-loaded’ with user-relevant information (e.g., a user's name, username, privileges, work schedule). The use of such a limited history also has the benefit of reducing the computational requirements to run the trained natural language model at inference time. Additionally, the use of the interpreter context reduces configuration requirements by mimicking the already-available and familiar interpreter environment that is already available for use by human agents. Further, the use of the interpreter context also makes a greater amount of training examples available to train the natural language model to engage in goal-oriented dialog, as significant amounts of training data of this variety are available.

Accordingly, a first example embodiment may involve a method that includes: (i) determining, via a trained natural language model, a first textual output based on a history, wherein the history indicates a representation of a first user query, and wherein the first textual output indicates a request for documentation regarding a first module of a plurality of application modules; (ii) applying the first textual output to an interpreter to generate a first interpreter output; (iii) updating the history by adding a representation of the first interpreter output to the history; (iv) applying the trained natural language model to the history based on the updated history to generate second textual output; and (v) applying the second textual output to the interpreter, wherein the second textual output comprises a first function call to a first function of the first module.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 is a history of interpreter commands and returns generated by the operation of a virtual agent, in accordance with example embodiments.

FIG. 7 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

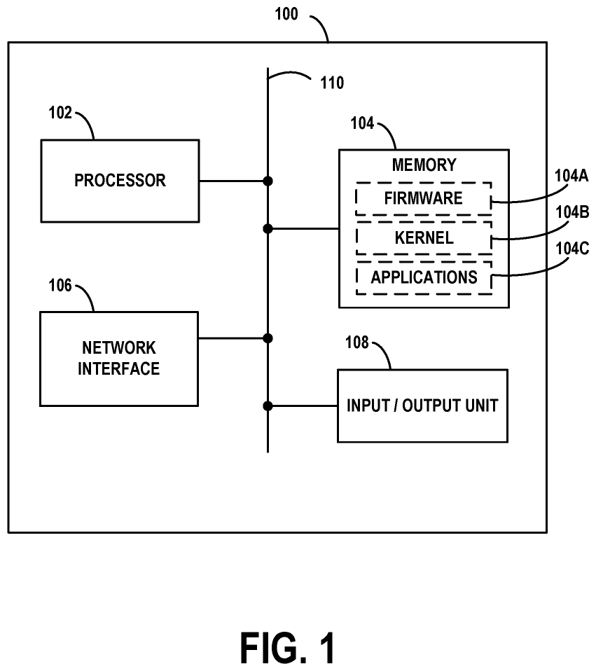

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

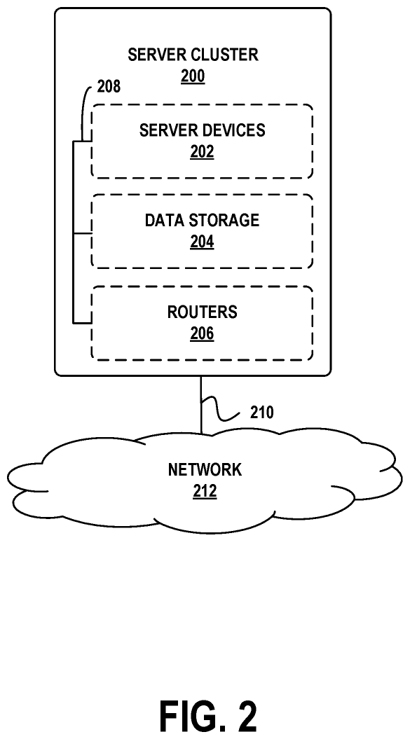

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

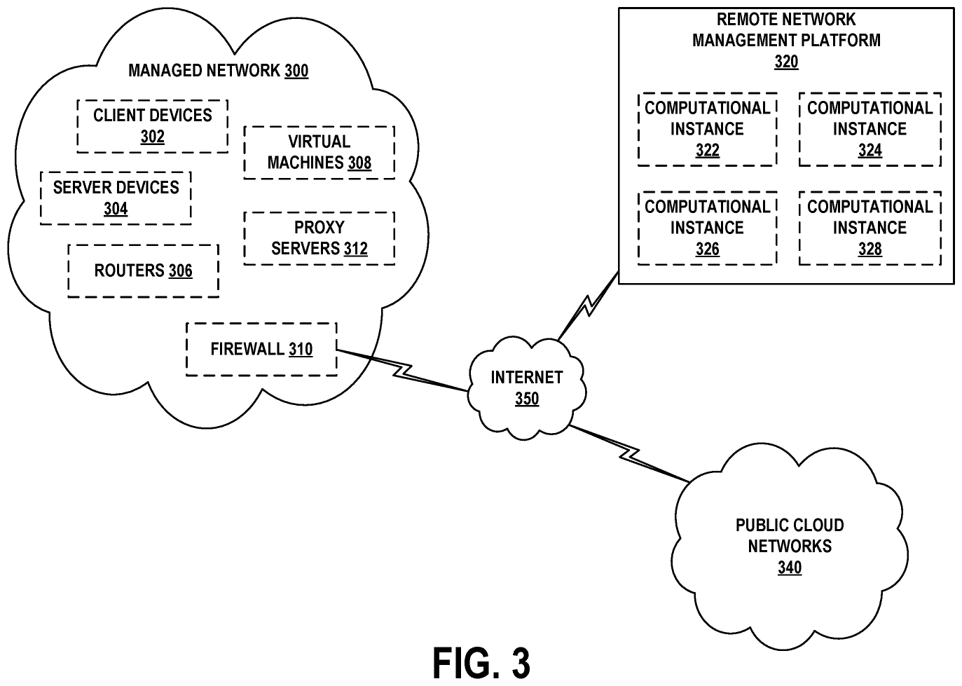

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

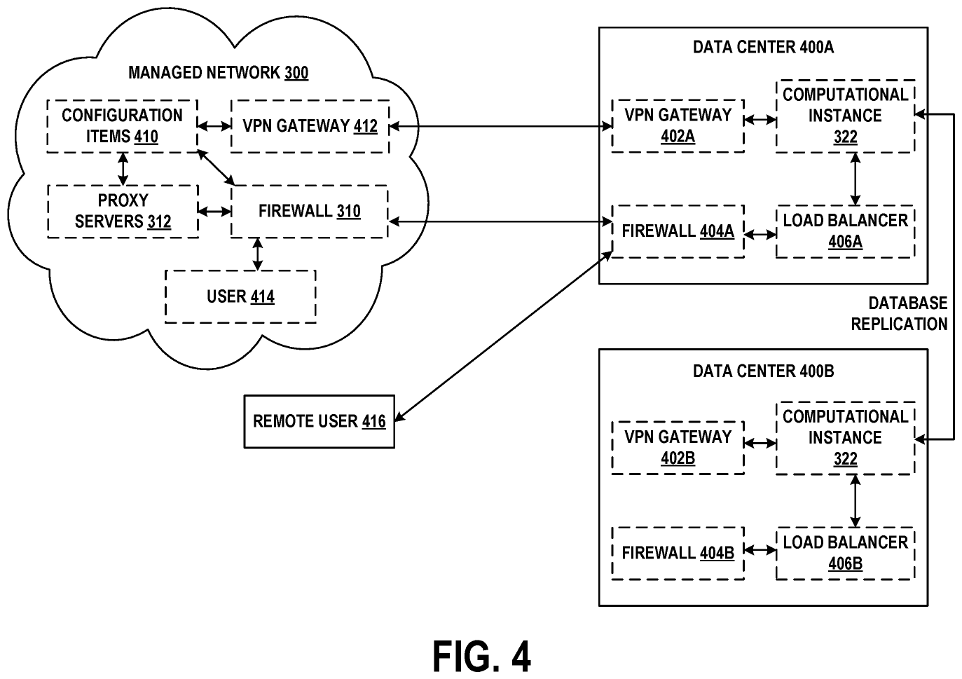

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

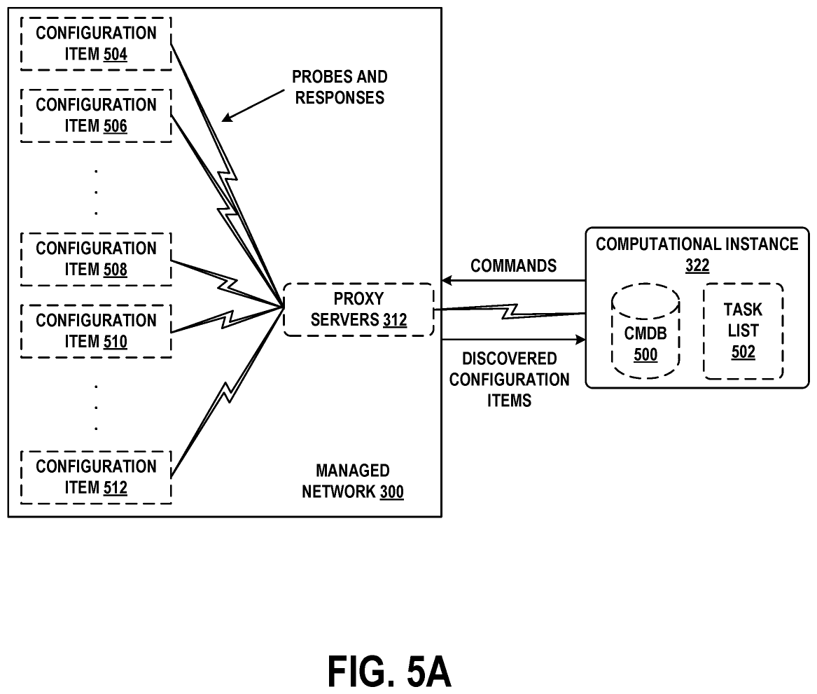

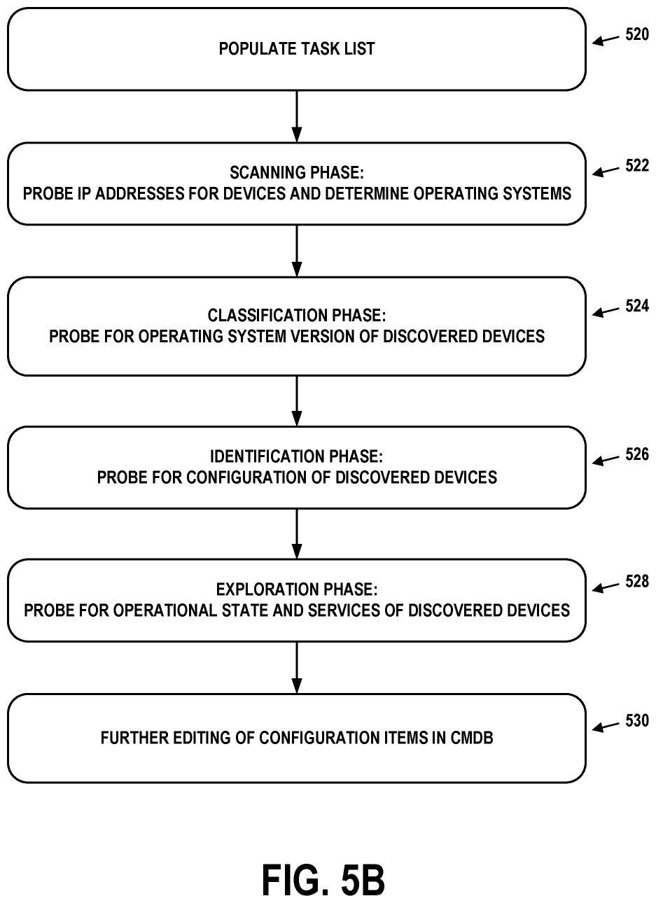

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Example Virtual Agents

Automated virtual agents can address certain user issues efficiently, avoiding escalation (and making such interactions more efficient by pre-gathering relevant user inputs and information). However, such virtual agents can require significant time to configure for a particular environment and application. Additionally, updates to the environment (e.g., addition, subtraction, and/or modification of application modules used by the virtual agent) can require additional effort to implement and/or additional computational resources to re-train the virtual agent to account for the updates. Such updates can occur regularly, imposing an ongoing training overhead.

The improved virtual agents described herein reduce or avoid the computational requirements of retraining virtual agents in response to such updates. These improved virtual agents achieve such benefits by including natural language models that have been trained to interact with a user and to engage with an interpreter or other environment in a goal-directed manner to accomplish the user's goals and commands. The natural language models are trained to generate interpreter commands based on a history that grows during a session of interaction with a user. The commands generated by the trained natural language model, as well as any responsive returns from the interpreter, are added to the history as they are input/received, and the trained natural language model is then applied to the updated history to generate the next model output. The use of such a limited input history can provide reduction in the inference-time computational requirements of executing the models relative to alternative methods.

Additionally, ‘resetting’ such a history at the beginning of each session (potentially retaining user-specific information like work schedule, name, system privileges) allows the trained model to update itself in response to changes in the interpreter environment (e.g., addition, subtraction, and/or modification of modules, commands, functions, or other aspects of the environment) in a low-overhead manner. This is accomplished by the model outputting commands to access information about the modules, commands, etc. available in the environment, thereby ‘re-learning’ current information about the environment as the responses to such commands are added to the history. This avoids the computational requirements of re-training the model in response to updates to the environment (e.g., by updating training examples to include reference to the updated functions, modules, commands, etc. and then re-training the model based on the updated training examples) and/or avoids re-configuring a virtual agent in response to such changes.

As noted above, operation of a trained natural language model as described herein can include applying the trained model to a history to generate an output. This output could represent a command to an interpreter, an output to a user (e.g., a request for additional information), and/or an indication to wait for additional input from a user (e.g., in response to a request for additional information sent to the user). The model outputs, along with any responses (from the interpreter and/or the user) are then added to the history, and the trained natural language model is then applied to the updated history to generate the next model output.

Outputs to the interpreter and/or use could be distinguished by a flag, a discrete output of the model, by being distinct outputs of the model, or by some other mechanism to indicate whether the output should be routed to the user or to the interpreter. In some examples, outputs to the user could be generated as function calls or other commands to the interpreter to present an output to the user. In such examples, operation of the model is simplified as all model output is presented to the interpreter. Similarly, responses from the user could be accessed by the model outputting a function call or command to obtain such responses (e.g., to wait for such a response, to return one or more stored previous responses from a buffer).

The use of such a natural language model virtual agent within the context of an interpreter (i.e., the use of the model to generate commands for and to receive responses from an interpreter) also provides a number of benefits. For example, such a scenario allows functionality developed for use by human agents (e.g., modules, commands, functions, documentation) to also be used, with no or minimal adaptation, by a virtual agent as described herein. Additionally, if the interpreter uses a common language (e.g., a version of Python), then more training examples are likely to be available for training the natural language model.

The natural language model is trained to engage in goal-oriented dialog, via an interpreter, to identify and accomplish a user's goals and/or commands. This includes training the natural language model to, based on an input history of model outputs and interpreter and/or user responses thereto, output commands to the interpreter to gain additional information about or potentially relevant to the user's goals/commands and/or to execute tasks to accomplish the user's goals/commands. This can include sending outputs to the interpreter to send queries or other information to the user (e.g., to request additional information that is necessary to accomplish the user's goals/commands) and to receive the user's response(s) thereto. This can also include sending outputs to the interpreter to return documentation or other information about commands, modules, or other functionality available within the interpreter environment.

For example, the natural language model could be trained to output commands to request, from the interpreter, a list of available modules and/or descriptive information about one or more of the modules. The natural language model could then, based on that information and on information from the user that is indicative of the user's goal(s), output additional commands to request, from the interpreter, information about one or more of the available modules that are likely to be relevant to the user's goal(s) (e.g., to request information about a reservation module when the user's initial query is to reserve a table at a restaurant). This could include, e.g., requesting a list of function, commands, and/or methods available within a module, requesting documentation related to such aspects of the module (e.g., human-language documentation for one or more functions, arguments lists for one or more functions) in aggregate or in relation to specific functions/commands/methods, or requesting some other information about the contents and capability of the module.

An interpreter could have available a variety of different modules that could be relevant to a user's goals and/or commands. For example, the interpreter could include a reservation module that includes methods for obtaining reservations for dining, transportation, lodging, conference rooms, office equipment, or other services or objects. Such a reservation module could accomplish such reservations by communicating with external systems (e.g., by communicating with an internet restaurant reservation service that manages restaurant reservations by communicating with individual restaurants and managing contracts or other relationships therewith) and/or by communicating with internal systems (e.g., an internal conference room reservation system that is not exposed to the internet). Such a reservation module could include functions, methods, or commands for searching for available restaurants or other services/objects of interest, e.g., based on geographic location, type of cuisine, time and date of availability, number of persons in a party, dietary restrictions, origin and destination of transit, type of transit desired, date/time of departure and/or return, cost level, number of seats, type of presentation equipment available, or some other consideration of the object/service to be reserved.

In another example, the interpreter could include a knowledgebase access module. Such a module could be used to access information of interest to a user (e.g., where a user's query is a request for information technology policy, human resources policy, other company policy, information about hardware or software, or other information contained in the knowledgebase). Additionally or alternatively, a natural language module as described herein could use such a module to access additional information that is relevant to accomplishing a user's goals or commands (e.g., to access information about how to accomplish the resolution of a technical problem that the user is having). In some examples, the knowledgebase access module could include functions or methods for modifying or updating the knowledgebase, e.g., to comply with a user command to update incorrect or out-of-date information and/or to update the knowledgebase based on information received from the user (e.g., based on an issue experienced by the user).

In another example, the interpreter could include a server management module. Such a module could be used to, to look up a status of software or hardware (e.g., to determine whether a relevant service is offline) or to look up some other information that is requested by a user and/or that is relevant to resolution of a user's goals or commands. Such a module could be used to reset hardware, software, or services to resolve a user's goals or commands (e.g., to restart an email service that is inaccessible).

In another example, the interpreter could include a user privileges modification and query module. Such a module could be used to look up information related to a user's status or permissions, to look up information related to hardware or software used by a user or otherwise relevant to a user's goals/commands, or to look up some other information that is requested by a user and/or that is relevant to resolution of a user's goals or commands. Such a module could be used to modify or reset a user's password (e.g., to send a password reset email), to change a user's permissions or status, or to make some other change with respect to a user's account or status on a server.

In another example, the interpreter could include a user biographical information modification or query module. Such a module could be used to look up information related to a user's schedule, work history, benefits information, payroll information, or other biographical information that is relevant to a user's goals/commands and/or that is requested by a user. Such a module could be used to modify such user information (e.g., to update a user's mailing address, to change user's payroll disbursements or routing) or to make some other change with respect to a user's biographical information.

In another example, the interpreter could include a database management or access module. Such a module could be used to look up information in a database (e.g., user privileges information, user biographical information). Such a module could be used to modify such information (e.g., to update a user's privileges, to update a user's biographical information) or to make some other change with respect to a user's biographical information.

In another example, the interpreter could include a telecommunications module. Such a module could be used to look up information via a telecommunications channel, medium, or online resource (e.g., to search for a telephone number, email address, social media handle, or other information about a specific person, to access stored past texts, chat messages, emails, voicemails, or other communications, to request social media posts or other requested available information via a telecommunications channel, medium, or online resource). Such a module could be used to send messages via a telecommunications channel, medium, or online resource (e.g., to send a text, email, chat message, or voicemail, to initiate a voice or video call, to make a post or send a message via a social media account).

In another example, the interpreter could include a map query module. Such a module could be used to look up information related to one or more maps. This could include looking up the location, address, phone number, hours, or other information available about one or more businesses or locations available in a map database. This could include retrieving directions on how to navigate from an origin location to a destination location. This could include searching for businesses or locations matching one or more search criteria (e.g., returning a list of businesses of a particular type within a specified distance of a user's location or of some other specified location).

The natural language model being trained to engage in goal-oriented dialog also includes training the natural language model to, based on information received from a user (e.g., one or more user queries, user responses to queries sent as outputs from the natural language model), generate one or more outputs to execute functions to accomplish the user's goals/commands. Such outputs could include function calls, commands, or other outputs to use the functionality of one or more modules of the interpreter to update a user's permissions, to send a password reset, to request a reservation at a restaurant, to look up information in a knowledgebase, to look up a human resources policy, to send a text message, or to perform some other action using one or more functions, commands, or methods available in one or more of the modules available within the interpreter.

Such a process could include generating an output that includes a function call (or other executable output) and attempting to verify whether the output is valid within the syntax of the interpreter, e.g., by generating an output that includes a ‘validate’ command or similar. The results of such an attempt could reveal that some additional information (e.g., additional function arguments) are required for the call to be valid. Alternatively, the natural language model could output such a function call without a separate attempt to validate, and an exception or other error information returned by the interpreter could reveal the needed additional information Such response(s) from the interpreter can be added to the history and, when the updated history is input to the natural language model, the natural language model could update the call based on other information in the history. Alternatively, the necessary additional information could be lacking in the history (e.g., the user could merely ask for a reservation at a particular restaurant, and the needed information could be a time for the reservation, such information having been lacking from the user's initial query). In such an example, the natural language model could output a request for the additional information to the user (e.g., in the form of a function call to the interpreter to present the user with an output that is indicative of a query for the additional information). Once the additional information is received from the user (and thus added to the history), the update history can then be input to the natural language model to generate an updated output that corrects the initial function call to account for the additional information (or to request additional needed information).

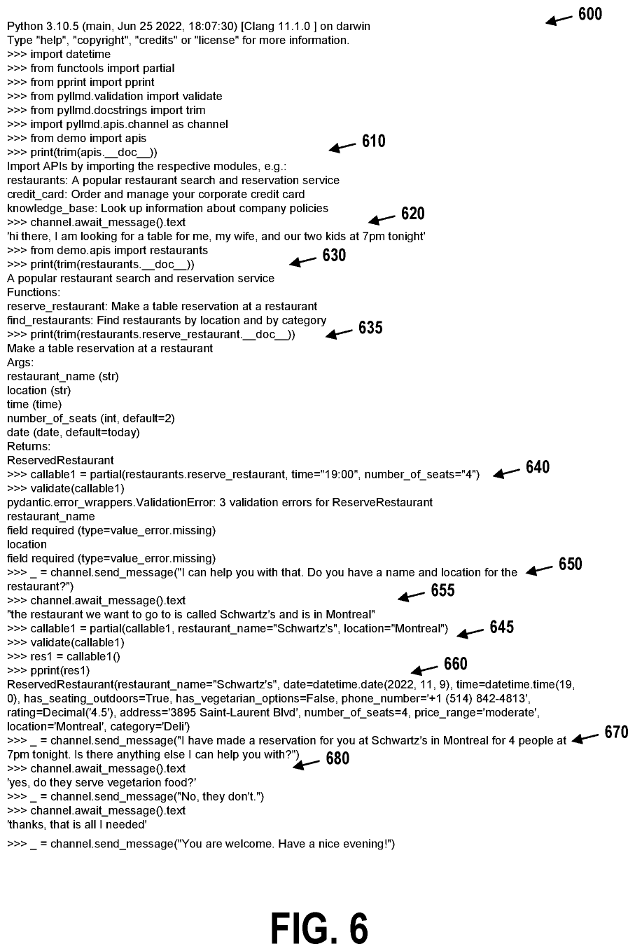

FIG. 6 illustrates an example of information, including outputs from a natural language model as described herein and interpreter responses thereto, that could form the contents of a history that is provided as input to such a model. Such a history would be, over time, expanded to include more and more of the illustrated example text. For example, an initial output of the natural language model, when presented with an ‘empty’ history (or with a history containing some default content, e.g., the ‘header’ information “Python 3.10.5 . . . ” provided at session initiation by the interpreter), could include a set of ‘default’ outputs (“>>>import datetime,” “>>>from functools import partial,” etc. shown in FIG. 6) that are applied to the interpreter. These outputs, along with the interpreter's response to such outputs (“Import APIs by importing . . . ,” etc.) are then added to the initial history. The updated history is then presented as input to the natural language model to generate additional output that is added to the history and that is also applied to the interpreter to, potentially, generate additional interpreter responses that are then added to the history. Such an iterative process continues until some termination criterion is reached, e.g., a user terminates a communication session, the model outputs a command to terminate the interpreter session, the model outputs a command to elevate the current session to a human agent.

As shown in FIG. 6, the model output can include a request for information about the modules that are available to the interpreter 610 (“print(trim(apis._doc_))”). As shown in FIG. 6, such a request may be made prior to receiving any query from the user. Alternatively, such a request may be made following, and in response to, receiving one or more queries from the user.

The model also receives an initial query from the user 620 (“hi there, I am looking for a table for me, my wife, and our two kids at 7 pm tonight”). This query can be received by the natural language model outputting a function call (“channel.await_message( ).text”) to the interpreter to obtain input from the user. A representation of the query (e.g., a copy of a string representing the query, a tokenized version thereof) is added to the history. The natural language model is then applied to the updated history, and the output generated therefrom by the model is a request for documentation about a relevant module 630 (“restaurants,” a restaurant reservation module) that is applied to the interpreter (“print(trim(restaurants._doc_))”). A representation of this output, along with the interpreter's response (“A popular restaurant search and reservation service . . . ”) is added to the history and the model applied to the updated history yet again to generate yet another model output.

This next model output is a request for documentation about a relevant function (“restaurants.reserve_restaurant”) of the relevant module 635. This output is then applied to the interpreter, and a representation of the query and the response (“Make a table reservation at a restaurant . . . ”) are added to the history. The natural language model is then applied to the updated history to generate yet another model output.

The next model output 640 is an attempt to determine whether a proposed method for accomplishing the user's goal (obtaining a restaurant reservation) will be successful by generating a ‘guess’ at the function call (“callable1=partial(restaurants.reserve_restaurant . . . ”), based on the current history (the fact that the user wants a restaurant reservation, for a party of four, at 7 pm) and then attempting to validate that ‘guess’ (“validate”). The interpreter response (“pydantic.error_wrappers . . . ”) includes an error message that contains information relevant to how the ‘guess’ is incorrect or malformed, and is added to the history. Alternatively, the model output could simply be an attempt to execute the ‘guess,’ and the exception or other error message returned by the interpreter could contain the information relevant to how the ‘guess’ is incorrect or malformed.

In the example of FIG. 6, the result of attempting to validate the ‘guess’ function call is that some information is missing (at least the identity and location of the restaurant). As a result, applying the natural language model to the history after it has been updated with the results of the validation has caused the model to generate an output to request additional information from the user related to the attempted/validated function call 650 (“channel.send_message(“I can help you with that . . . )). A responsive reply from the user 655 (“the restaurant we want is . . . ,” obtained by sending applying another model output to obtain such reply “channel.await_message( ).text”) is then received and added to the history.

The next model output, obtained by applying the model yet again to the updated history, when applied to the interpreter results in an updated version of the function call being executed to accomplish the user's goal/command 660. In the illustrated example, this amounts to an update to the pre-existing “callable1” object, followed by execution of the updated “callable1” object (“res1=callable1( )”). In the example of FIG. 6, the model also, prior to executing the updated function call, attempts to validate the updated function call.

The repeated process of adding to the history and then applying the model to the updated history to generate additional model output(s) to apply to the interpreter can then continue until an end condition (e.g., the user terminating the session, the model output containing an interpreter command to terminate the session and/or elevate the session to a human agent). For example, subsequent model outputs could be commands to inform the user of the outcome of executing the final function call 670 (“_=channel.send_message(“I have made a reservation for you . . . ”), awaiting additional user queries/input 680, and proceeding based on that additional user input.

Note that, while the history shown in combination with FIG. 6 is ‘empty’ prior to the beginning of the illustrated session (i.e., the history begins with the ‘header’ text that the interpreter provides upon session initiation), in some examples the history could be pre-populated with information. For example, the history could be pre-populated with a representation of (i) a past interaction with the user (e.g., all or a portion of the history from one or more previous sessions with the user), (ii) information about the user (e.g., the user's name, status, position, privileges, work schedule, current project(s)), (ii) a list of modules accessible by the interpreter, and/or some other information that is likely to be useful.

The natural language model could be trained in a variety of ways, using a variety of types of training data. In some examples, the natural language model could be a very large (e.g., a model including more than one billion parameters), generic model that has been trained on a large corpus of text, including generic speech (e.g., GPT-3). In such an example, additional ‘training’ of the model to engage in the sort of goal-directed dialog, within an interpreter context, as is described herein includes adding to the history two or more examples of such goal-oriented dialog sessions.

In some examples, the natural language model could be a smaller model whose parameters have been trained to engage in goal-oriented dialog by using examples of sessions of text that represent such activity. Such training examples could be obtained by assembling a corpus of examples from the internet (e.g., examples of interpreter-interaction sessions created by human agents engaging in goal-directed dialog) that may include examples of syntax within the interpreter (e.g., examples of Python commands and returns) and/or examples within alternative interpreters. The set of training examples could include examples of a variety of different goal-oriented tasks/commands/user interactions, including one or more examples of each of calling a function, receiving an exception in response to calling a function, loading a module, loading documentation about a module or a function, receiving a query from a user, and generating a response to a user.

### VI. Example Operations

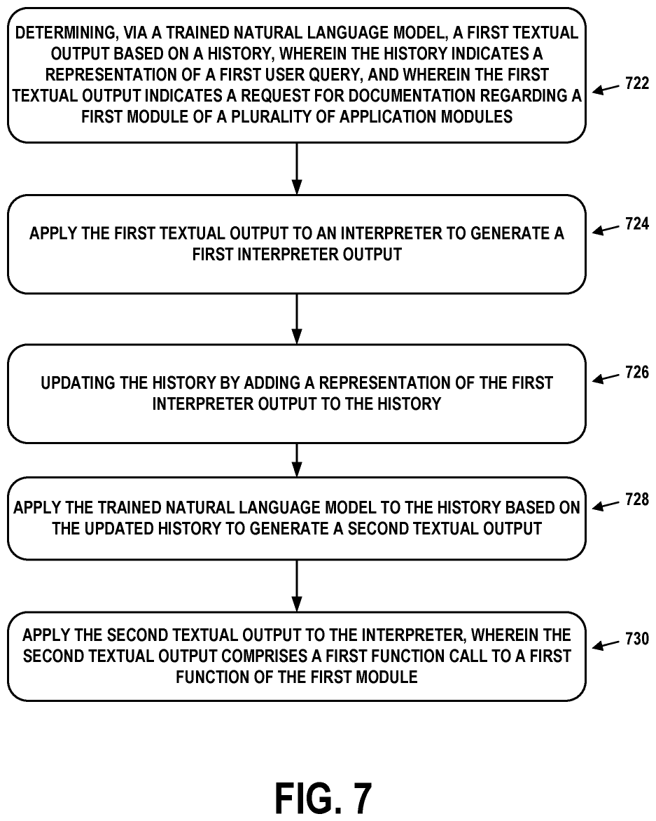

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

The embodiments of FIG. 7 include determining, via a trained natural language model, a first textual output based on a history, wherein the history indicates a representation of a first user query, and wherein the first textual output indicates a request for documentation regarding a first module of a plurality of application modules (722). The trained natural language model could include more than a billion parameters and could have been trained on a corpus of generic speech, and the history could include, prior to adding a representation of the first query thereto, representations of at least two examples of goal-oriented dialog using the interpreter. Alternatively, the trained natural language model could have been trained using a plurality of representations of goal-oriented dialog using the interpreter. For example, the plurality of representations of goal-oriented dialog using the interpreter used to train the trained natural language model could include a representation of at least one instance of each of: calling a function, receiving an exception in response to calling a function, loading a module, loading documentation about a module or a function, receiving a user query, and generating a user response.

The embodiments of FIG. 7 include applying the first textual output to an interpreter to generate a first interpreter output (724). The first module could be at least one of a knowledgebase query module, a reservation module, a server management module, a database management or access module, a user privileges modification or query module, a user biographical information modification or query module, a telecommunications module, a commercial services query module, or a map query module.

The embodiments of FIG. 7 include updating the history by adding a representation of the first interpreter output to the history (726).

The embodiments of FIG. 7 include applying the trained natural language model to the history based on the updated history to generate second textual output (728).

The embodiments of FIG. 7 include applying the second textual output to the interpreter, wherein the second textual output comprises a first function call to a first function of the first module (730).

The embodiments of FIG. 7 could include additional steps, aspects, or features. For example, the embodiments of FIG. 7 could additionally include, in response to receiving a the first user query, adding a representation of the first user query to the history. In some examples, the history could include, prior to adding a representation of the first user query thereto, a representation of at least one of a past interaction with the user, information about the user, or a list of modules accessible by the interpreter.

Additionally or alternatively, the embodiments of FIG. 7 could additionally include receiving the first user query by: (i) generating, using the trained natural language model, a third textual output; (ii) applying the third textual output to the interpreter, wherein the third textual output comprises a command to return at least one prior user input; and (iii) receiving a second interpreter output from the interpreter in response to applying the third textual output thereto, wherein the second interpreter output is representative of the first query.

Additionally or alternatively, the embodiments of FIG. 7 could additionally include: (i) adding a representation of a second interpreter output to the history, wherein the second interpreter output is received from the interpreter in response to applying the second textual output thereto; (ii) subsequent to adding the representation of the second interpreter output to the history, applying the trained natural language model to the history to generate third textual output; and (iii) presenting a representation of the third textual output. For example, presenting a representation of the third textual output could include applying the third textual output to the interpreter, wherein the third textual output comprises a command to provide a representation of the second interpreter output.

Additionally or alternatively, the embodiments of FIG. 7 could additionally include: (i) adding a representation of a second interpreter output to the history, wherein the second interpreter output is received from the interpreter in response to applying the second textual output thereto, and wherein the second interpreter output includes an error message; (ii) subsequent to adding the representation of the second interpreter output to the history, applying the trained natural language model to the history to generate third textual output, wherein the third textual output represents a request for additional information related to the first function call; (iii) presenting a representation of the third textual output; (iv) responsive to presenting the representation of the third textual output, receiving a first user response; (v) in response to receiving the first user response, adding a representation of the first user response to the history; (vi) subsequent to adding the representation of the first user response to the history, applying the trained natural language model to the history to generate fourth textual output; and (vii) applying the fourth textual output to the interpreter, wherein the fourth textual output comprises a second function call to the first function of the first module. For example, presenting a representation of the third textual output could include applying the third textual output to the interpreter, the third textual output could include a command to provide a representation of the second interpreter output, and receiving the first user response could include: (i) generating, using the trained natural language model, a fifth textual output; (ii) applying the fifth textual output to the interpreter, wherein the fifth textual output comprises a command to return at least one prior user input; and (iii) receiving a third interpreter output from the interpreter in response to applying the fifth textual output thereto, wherein the third interpreter output is representative of the first user response.

Additionally or alternatively, the embodiments of FIG. 7 could additionally include: (i) receiving the first user query; (ii) adding a representation of the first user query to the history; and (iii) prior to receiving the first user query: (a) generating, using the trained natural language model, a third textual output; (b) applying the third textual output to the interpreter, wherein the third textual output comprises a request to return information about a set of modules that are usable by the interpreter, wherein the first module is a member of the set of modules; (c) receiving a second interpreter output from the interpreter in response to applying the third textual output thereto, wherein the second interpreter output is representative of capabilities of each module of the set of modules; and (d) adding a representation of the second interpreter output to the history.

Additionally or alternatively, the embodiments of FIG. 7 could additionally include, prior to applying the trained natural language model to the history to generate the second textual output and subsequent to adding the representation of the first interpreter output to the history: (i) applying the trained natural language model to the history to generate third textual output; (ii) applying the third textual output to the interpreter, wherein the third textual output comprises a request for at least one of information about the first module or information about the first function; and (iii) adding a representation of a second interpreter output to the history, wherein the second interpreter output is received from the interpreter in response to applying the third textual output thereto.

### VII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
determining, via a trained natural language model, a first textual output based on a history, wherein the history indicates a representation of a first user query, and wherein the first textual output indicates a request for documentation regarding a first module of a plurality of application modules;
applying the first textual output to an interpreter to generate a first interpreter output;
updating the history by adding a representation of the first interpreter output to the history, wherein the first interpreter output is received from the interpreter in response to applying the first textual output thereto;
applying the trained natural language model to the history based on the updated history, to generate a second textual output; and
applying the second textual output to the interpreter, wherein the second textual output comprises a first function call to a first function of the first module.

2. The method of claim 1, further comprising receiving the first user query by:
generating, using the trained natural language model, a third textual output;
applying the third textual output to the interpreter, wherein the third textual output comprises a command to return at least one prior user input; and
receiving a second interpreter output from the interpreter in response to applying the third textual output thereto, wherein the second interpreter output is representative of the first user query.

3. The method of claim 1, wherein the first module is at least one of a knowledgebase query module, a reservation module, a server management module, a database management or access module, a user privileges modification or query module, a user biographical information modification or query module, a telecommunications module, a commercial services query module, or a map query module.

4. The method of claim 1, further comprising:
adding a representation of a second interpreter output to the history, wherein the second interpreter output is received from the interpreter in response to applying the second textual output thereto;
subsequent to adding the representation of the second interpreter output to the history, applying the trained natural language model to the history to generate third textual output; and
presenting a representation of the third textual output.

5. The method of claim 4, wherein presenting a representation of the third textual output comprises:
applying the third textual output to the interpreter, wherein the third textual output comprises a command to provide a representation of the second interpreter output to a user.

6. The method of claim 1, further comprising:
adding a representation of a second interpreter output to the history, wherein the second interpreter output is received from the interpreter in response to applying the second textual output thereto, and wherein the second interpreter output includes an error message;
subsequent to adding the representation of the second interpreter output to the history, applying the trained natural language model to the history to generate third textual output, wherein the third textual output represents a request for additional information related to the first function call;
presenting a representation of the third textual output;
responsive to presenting the representation of the third textual output, receiving a first user response;
in response to receiving the first user response, adding a representation of the first user response to the history;
subsequent to adding the representation of the first user response to the history, applying the trained natural language model to the history to generate fourth textual output; and
applying the fourth textual output to the interpreter, wherein the fourth textual output comprises a second function call to the first function of the first module.

7. The method of claim 6, wherein presenting a representation of the third textual output comprises applying the third textual output to the interpreter, wherein the third textual output comprises a command to provide a representation of the second interpreter output to a user, and wherein receiving the first user response comprises:
generating, using the trained natural language model, a fifth textual output;
applying the fifth textual output to the interpreter, wherein the fifth textual output comprises a command to return at least one prior user input; and
receiving a third interpreter output from the interpreter in response to applying the fifth textual output thereto, wherein the third interpreter output is representative of the first user response.

8. The method of claim 1, further comprising:
receiving the first user query;
adding a representation of the first user query to the history; and
prior to receiving the first user query:
generating, using the trained natural language model, a third textual output;
applying the third textual output to the interpreter, wherein the third textual output comprises a request to return information about a set of modules that are usable by the interpreter, wherein the first module is a member of the set of modules;
receiving a second interpreter output from the interpreter in response to applying the third textual output thereto, wherein the second interpreter output is representative of capabilities of each module of the set of modules; and
adding a representation of the second interpreter output to the history.

9. The method of claim 1, further comprising, prior to applying the trained natural language model to the history to generate the second textual output and subsequent to adding the representation of the first interpreter output to the history:
applying the trained natural language model to the history to generate third textual output;
applying the third textual output to the interpreter, wherein the third textual output comprises a request for at least one of information about the first module or information about the first function; and
adding a representation of a second interpreter output to the history, wherein the second interpreter output is received from the interpreter in response to applying the third textual output thereto.

10. The method of claim 1, wherein the trained natural language model includes more than a billion parameters and has been trained on a corpus of generic speech, and wherein the history includes, prior to adding a representation of the first user query thereto, representations of at least two examples of goal-oriented dialog using the interpreter.

11. The method of claim 1, wherein the trained natural language model has been trained using a plurality of representations of goal-oriented dialog using the interpreter.

12. The method of claim 11, wherein the plurality of representations of goal-oriented dialog using the interpreter used to train the trained natural language model comprises a representation of at least one instance of each of: calling a function, receiving an exception in response to calling a function, loading a module, loading documentation about a module or a function, receiving a user query, and generating a user response.

13. The method of claim 1, wherein the history includes, prior to adding a representation of the first user query thereto, a representation of at least one of a past user interaction, information about the user, or a list of modules accessible by the interpreter.

14. An article of manufacture including a non-transitory computer-readable medium, having stored thereon program instructions that, upon execution by a computing system, cause the computing system to perform operations comprising:
determining, via a trained natural language model, a first textual output based on a history, wherein the history indicates a representation of a first user query, and wherein the first textual output indicates a request for documentation regarding a first module of a plurality of application modules;
applying the first textual output to an interpreter to generate a first interpreter output;
updating the history by adding a representation of the first interpreter output to the history;
applying the trained natural language model to the history based on the updated history to generate a second textual output; and
applying the second textual output to the interpreter, wherein the second textual output comprises a first function call to a first function of the first module.

15. The article of manufacture of claim 14, wherein the operations further comprise:
adding a representation of a second interpreter output to the history, wherein the second interpreter output is received from the interpreter in response to applying the second textual output thereto;
subsequent to adding the representation of the second interpreter output to the history, applying the trained natural language model to the history to generate third textual output; and
presenting a representation of the third textual output.

16. The article of manufacture of claim 14, wherein the operations further comprise:
adding a representation of a second interpreter output to the history, wherein the second interpreter output is received from the interpreter in response to applying the second textual output thereto, and wherein the second interpreter output includes an error message;
subsequent to adding the representation of the second interpreter output to the history, applying the trained natural language model to the history to generate third textual output, wherein the third textual output represents a request for additional information related to the first function call;
presenting a representation of the third textual output;
responsive to presenting the representation of the third textual output, receiving a first user response;
in response to receiving the first user response, adding a representation of the first user response to the history;
subsequent to adding the representation of the first user response to the history, applying the trained natural language model to the history to generate fourth textual output; and
applying the fourth textual output to the interpreter, wherein the fourth textual output comprises a second function call to the first function of the first module.

17. The article of manufacture of claim 16, wherein presenting a representation of the third textual output comprises applying the third textual output to the interpreter, wherein the third textual output comprises a command to provide a representation of the second interpreter output, and wherein receiving the first user response comprises:
generating, using the trained natural language model, a fifth textual output;
applying the fifth textual output to the interpreter, wherein the fifth textual output comprises a command to return at least one prior user input; and
receiving a third interpreter output from the interpreter in response to applying the fifth textual output thereto, wherein the third interpreter output is representative of the first user response.

18. The article of manufacture of claim 14, wherein the operations further comprise:
receiving the first user query;
adding a representation of the first user query to the history; and
prior to receiving the first user query:
generating, using the trained natural language model, a third textual output;
applying the third textual output to the interpreter, wherein the third textual output comprises a request to return information about a set of modules that are usable by the interpreter, wherein the first module is a member of the set of modules;
receiving a second interpreter output from the interpreter in response to applying the third textual output thereto, wherein the second interpreter output is representative of capabilities of each module of the set of modules; and
adding a representation of the second interpreter output to the history.

19. The article of manufacture of claim 14, wherein the operations further comprise, prior to applying the trained natural language model to the history to generate the second textual output and subsequent to adding the representation of the first interpreter output to the history:
applying the trained natural language model to the history to generate third textual output;
applying the third textual output to the interpreter, wherein the third textual output comprises a request for at least one of information about the first module or information about the first function; and
adding a representation of a second interpreter output to the history, wherein the second interpreter output is received from the interpreter in response to applying the third textual output thereto.

20. The article of manufacture of claim 14, wherein the history includes, prior to adding a representation of the first user query thereto, a representation of at least one of a past user interaction, information about the user, or a list of modules accessible by the interpreter.
